(19) United States
(12) Patent Application Publication
(10) Pub. No.: US 2012/0255692 A1
(43) Pub. Date: Oct. 11, 2012

(54) Bleach compositions and related methods

(76) Inventor: Roy W. Martin, Downers Grove, IL (US)

(21) Appl. No.: 13/066,199

(22) Filed: Apr. 8, 2011

(51) Int. Cl. D21C 9/12; C09K 3/00

(52) U.S. Cl. 162/74; 252/187.31

(57) ABSTRACT

The invention relates to bleach compositions comprising organic acyl polyoxychlorine and methods for producing said bleach compositions. The bleach compositions form reactive oxygen species when contacted by chromophores.

### FIELD OF INVENTION

The present invention relates to bleach compositions and methods for bleaching.

### BACKGROUND

Oxidizing bleaches are commonly used in various applications exemplified by laundry, dishwashing, hard surfaces cleaning and paper pulp delignification.

Chlorine dioxide, sodium hypochlorite, hydrogen peroxide, and peracetic acid are commonly used bleach compositions for these types of applications.

U.S. Pat. No. 4,493,751 relates to polyoxymethylene fibrids with a reduced specific viscosity of 0.4 to 2.0 dl/g, a specific surface area of 50 to 200 m.sup.2 /g and a freeness of 30.degree. to 80.degree. SR. The fibrids are produced by flash-evaporation of a superheated solution of the polymer, a mixture of 50-95% by weight of a lower alcohol with 1-4 C atoms and 5-50% by weight of water being used as the solvent and are suitable for the production of paper.

A search of patents and publications disclose the use of organic perchlorates as activators for polymerization reactions. No prior art has been obtained regarding using organic perchlorates and organic chlorates for the purpose of bleaching laundry or bleaching paper pulp.

### SUMMARY OF THE INVENTION

The present invention is based on the discovery that organic acyl polyoxychlorine compounds can be produced and/or stored in the form of an aqueous solution. These powerful oxidizing compounds were found to be unexpectedly stable in an aqueous solution as long as the pH is less than about 5.0. However when the pH is increased much above 5.0 and oxidizable organics are contacted with the aqueous solution, the organic acyl polyoxychlorine compounds undergo extremely vigorous decomposition. The ability to produce organic acyl polyoxychlorine compounds in an aqueous solution as well as stabilize and store these compounds in an aqueous solution brings to light a new generation of bleach compositions that provide unprecedented performance and environmentally benign byproducts. Many of the disclosed bleach compositions when decomposed result in compounds Generally Regarded As Safe (GRAS).

A chromophore is the part of a molecule responsible for its color. The color arises when a molecule absorbs certain wavelengths of visible light and transmits or reflects others. The chromophore is a region in the molecule where the energy difference between two different molecular orbitals falls within the range of the visible spectrum. Visible light that hits the chromophore can thus be absorbed by exciting an electron from its ground state into an excited state.

In the conjugated chromophores, the electrons jump between energy levels created by a series of alternating single and double bonds, often in aromatic systems. Common examples include various food colorings, fabric dyes (azo compounds), pH indicators, lycopene, β-carotene, and anthocyanins. Various factors in a chromophore's structure go into determining at what wavelength region in a spectrum the chromophore will absorb. Lengthening or extending a conjugated system with more unsaturated (multiple) bonds in a molecule will tend to shift absorption to longer wavelengths.

The metal complex chromophores arise from the binding of a transition metal to ligands. Examples of such chromophores can be seen in chlorophyll (used by plants for photosynthesis), hemoglobin, hemocyanin, and colorful minerals such as malachite and amethyst.

The bleach compositions of the invention comprise organic acyl polyoxychlorine compounds that are in the form of an aqueous solution. The application of the organic acyl polyoxychlorine based compositions is extremely effective at oxidizing chromophores.

Paper pulp comprises lignin which is a chromophore that binds the cellulose of wood fiber together. Residual lignin in paper imparts an undesirable color and acidity to the paper. Bleaching is used to break the lignin ring thereby freeing the cellulose and whitening the cellulose for use in paper.

Clothing is often stained with undesirable chromophores that are difficult to remove during laundering. Sources of well known chromophores that stain clothing include tomato juice, wine, grape juice, grass stains, blood and the like.

There is a need for an effective, fast acting and environmentally friendly bleach that can facilitate the oxidation of chromophores without damaging the fabric of laundry, cellulose of paper pulp, and does not form undesirable decomposition byproducts like dioxin.

The present invention is deemed to meet this and other needs in a unique and highly facile way.

Acid anhydrides have been used in producing chlorine dioxide as an acidulent or in direct reaction with alkali and earth alkali chlorites. Alkali and earth alkali chlorates have been used to produce chlorine dioxide by reduction of chlorates in strong acid solutions.

It has been discovered that organic acyl polyoxychlorine compounds can be produced that are stable in aqueous solutions and provide extremely efficient and effective bleach compositions.

While several methods for producing the bleach composition of the invention will be introduced, one expedient method comprises contacting an acid anhydride with an aqueous solution of polyoxychlorine anions comprising at least one of a chlorate anion having the general formula ClO₃⁻ and a perchlorate anion having the general formula ClO₄⁻. The reaction is allowed to continue until the acid anhydride is substantially depleted. The pH of the aqueous bleach composition should be less than or equal to 7.0, more preferably a pH of less than 6.0, and most preferably a pH of less than 5.0. Once the bleach composition has been produced, the pH may be adjusted to meet the needs of the application.

The resulting bleach compositions in the form of an aqueous solution were found to be unexpectedly stable, especially at a pH of less than 5.0. However, when the pH is increased much above 5.0 and the bleach composition is contacted by an oxidizable organic, the bleach composition undergoes extremely vigorous decomposition even at relatively low concentrations. The reduction of the bleach compositions of the invention results in formation of reactive oxygen species. Once the bleach composition is produced, it can be applied to applications having an alkaline pH. Specific non-limiting examples of applications having an alkaline pH include laundry and dishwashing.

In one embodiment of the invention, there is provided a bleach composition in the form of an aqueous solution comprising:

at least one organic acyl polyoxychlorine having the general formula

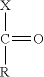

wherein (X) comprises a polyoxychlorine selected from at least one of a chlorate having the general formula ClO₃ and perchlorate having the general formula ClO₄;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water.

In another embodiment of the invention, a method of making a bleach composition comprising at least one organic acyl polyoxychlorine having the general formula

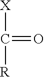

wherein (X) comprises a polyoxychlorine selected from at least one of a chlorate having the general formula ClO₃ and perchlorate having the general formula ClO₄⁻;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water, the method comprising:

contacting an acid anhydride comprising two acyl groups bound at a common oxygen and wherein each of the acyl groups are bound to one of: an alkyl group having from 1 to 6 carbon atoms; an aryl group having 6 carbon atoms; a common carbon based backbone comprising 2 to 6 carbon atoms, with an aqueous solution comprising polyoxychlorine anions selected from at least one of chlorate anions having the general formula ClO₃⁻ and perchlorate anions having the general formula ClO₄⁻; and

reacting the acid anhydride and polyoxychlorine anions until the acid anhydride is substantially depleted to form the biocide composition having a pH of less than or equal to 7.0.

In another embodiment of the invention, a method of making a bleach composition comprising at least one organic acyl polyoxychlorine having the general formula

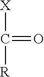

wherein (X) comprises a polyoxychlorine selected from at least one of a chlorate having the general formula ClO₃ and perchlorate having the general formula ClO₄;

wherein (R) comprising one of: 2 to 6 carbon based alkyl group terminating at a carboxyl functional group; 2 carbon based alkene group terminating at a carboxyl functional group; and water, the method comprising:

contacting a cyclic anhydride comprising two acyl groups bound to a common oxygen atom and having a common carbon based backbone having from 2 to 6 carbon atoms with an aqueous solution comprising polyoxychlorine anions selected from at least one of a chlorate anions having the general formula ClO₃⁻ and a perchlorate anions having the general formula ClO₄⁻; and

reacting the cyclic anhydride and polyoxychlorine anions until the cyclic anhydride is substantially depleted to form the bleach composition having a pH of less than or equal to 7.0.

In yet another embodiment of the invention, a bleach composition for bleaching chromophores of paper pulp comprising at least one of acetyl chlorate and acetyl perchlorate. The bleach composition is in the form of an aqueous solution having a pH of greater than 4.5.

In yet another embodiment of the invention, a bleach composition in the form of an aqueous solution comprising:

An organic diacyl dipolyoxychlorine having the general formula

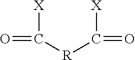

wherein (R) comprises a common carbon based backbone having from 2 to 6 carbon atoms;

wherein (X) comprises a polyoxychlorine selected from at least one of a chlorate having the general formula ClO₃ and perchlorate having the general formula ClO₄, and water.

In yet another embodiment of the invention, a method of bleaching chromophores comprising: contacting chromophores with an aqueous bleach composition comprising organic acyl polyoxychlorine having the general formula:

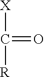

wherein (X) comprises a polyoxychlorine selected from at least one of a chlorate having the general formula ClO₃ and perchlorate having the general formula ClO₄; wherein (R) comprising at least one of 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group;

wherein the aqueous bleach composition has a pH of greater than 4.5.

In yet another embodiment of the invention, a method of bleaching chromophores comprising: contacting chromophores with an aqueous bleach composition comprising organic diacyl dipolyoxychlorine having the general formula:

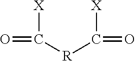

wherein (X) comprises a polyoxychlorine selected from at least one of a chlorate having the general formula ClO₃ and perchlorate having the general formula ClO₄; wherein (R) comprising a common carbon based backbone having from 2 to 6 carbon atoms;

wherein the aqueous bleach composition has a pH of greater than 4.5.

### DETAILED DESCRIPTION OF THE EMBODIMENT(S)

Chemical pulp, the raw material in paper, is not naturally white; its light color or pure whiteness is the result of a multi-phased bleaching process. Bleaching means removing or altering the color substances in the pulp. It is done in phases.

The darkness of chemical pulp is caused by lignin, the natural adhesive that binds wood fibers together. A key issue in bleaching is how the lignin is processed, i.e. how much lignin is removed from the pulp. Typically, chemical pulp is bleached by removing lignin and mechanical pulp by preserving it. If lignin is removed from the pulp, the pulp remains brighter longer and yellows more slowly later.

The objectives of bleaching are usually to lighten the color of the pulp, preserve brightness, improve cleanliness, or reduce pitch content.

Bleaching improves the cleanliness of the pulp. When the last of the lignin is removed from the pulp, the fibers of the fiber bundles, i.e. the shives, are released and any remaining bark debris dissolves. The chemicals used in bleaching also effectively dissolve any extractives contained in the pulp.

The chemical pulp stock is bleached in several separate phases. In between each phase it is washed. By alternating the bleaching and washing phases, the pulp can be made very bright without compromising its structure and strength. The bleaching of the chemical pulp stock takes place in the pulp mill's bleaching plant.

Elemental Chlorine Free (EFC) bleaching does not use chlorine gas or hypochlorite, but chlorine dioxide is used in one or more phases. In a chemical reaction, the dissolved lignin is extracted from the pulp with some type of alkali.

Small amounts of hydrogen peroxide can be mixed into the pulp before the first alkali phase to improve delignification. Also small amounts of hydrogen peroxide improve delignification in the alkali phase. ECF bleaching can remove virtually all the residual lignin, thereby turning the sulphate pulp into fully bleached pulp.

Total Chlorine Free (TCF) bleaching does not use any chlorine chemicals, but e.g. peroxide and ozone are used.

Ozone removes residual lignin from pulp stock more effectively than peroxide. When the effect of the peroxide is supplemented with ozone, it is possible to achieve very bright softwood sulphate pulp.

The ozone phase requires special equipment. Moreover, ozone cannot be stored, so it must be produced on-site.

It has been discovered that stable organic acyl polyoxychlorine compositions can be produced in an aqueous solution and are extremely effective bleach compositions for oxidizing chromophores such as lignin using essentially reactive oxygen species. These compositions provide superior bleaching compared to other oxidizing bleaches namely sodium hypochlorite, hydrogen peroxide, and chlorine dioxide.

Of significant interest is a bleach composition in the form of an aqueous solution comprising:

at least one organic acyl polyoxychlorine having the general formula

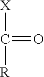

wherein (X) comprises a polyoxychlorine selected from at least one of a chlorate having the general formula ClO₃ and perchlorate having the general formula ClO₄;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water.

Furthermore, of significant benefit is while the bleach compositions of the invention comprise chlorate and/or perchlorate, the reduction of the bleach composition results in compounds Generally Regarded As Safe (GRAS). The reduction of the bleach compositions results in a cascading release of oxygen, terminating with an organic acid. For example, succinyl chlorate is reduced to oxygen, chloride salt and succinic acid. These environmentally benign byproducts are suitable for use in food and impose negligible environmental impact.

### BACKGROUND

Organic perchlorates have been used in polymerization reactions for many years and they are still used today. Organic perchlorates are powerful oxidizers that are known to be extremely hazardous.

With reference to the publication “1988 Russ. Chem. Rev. 57 1041”, Titled “The Synthesis and Properties of Covalent Organic Perchlorates”.

Numerous methods for producing organic perchlorates are reviewed. Common methods discussed in the referenced paper include reacting alcohols with perchloric acid under tightly controlled temperatures to form perchloric acid mono and poly esters. However, the resulting organic perchlorates are oil based, and when contacted with dilute amounts of water decompose resulting in an “enormously powerful explosions”.

Furthermore, the reference discloses cyclic ethers including epoxides can be reacted with chlorine heptoxide in an organic solvent at 0° C. to produce diperchlorates.

It has been discovered that organic acyl polyoxychlorine compounds comprising organic perchlorates and organic chlorates can be produced and/or stabilized and stored in an aqueous solution. The invention is based on the discovery that the stability of organic acyl polyoxychlorine compounds in an aqueous solution is very dependent on pH. At a pH of less than about 5.0, the organic acyl polyoxychlorine compounds were unexpectedly stable and can be stored for more than several weeks with negligible loss in activity. In fact, test comprising whey protein addition showed no reaction between the whey protein and aqueous solutions comprising organic acyl polyoxychlorine compounds when the pH was approximately much less than about 5.0. However, when the pH was increased much above 5.0 the reaction was vigorous, causing a rapid release of gas and foam formation.

The bleach compositions of the present invention can be produced using many techniques. Specific non-limiting examples include producing an organic diacyl dipolyoxychlorine by reacting in an organic solvent, an organic diacyl dichloride or organic diacyl alcohol with a source of perchlorate anions or chlorate anions. The resulting solution comprising the organic diacyl dipolyoxychlorine is then washed by diluting in an excess of acidified water to recover the organic diacyl dipolyoxychlorine in the form of an aqueous solution. The acidified water should be buffered to maintain a pH of no more than 5.0, more preferably less than 4.0.

The resulting bleach composition having the general formula:

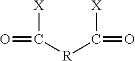

wherein (X) comprises a polyoxychlorine selected from at least one of a chlorate having the general formula ClO₃ and perchlorate having the general formula ClO₄; wherein (R) comprising a common carbon based backbone having from 2 to 6 carbon atoms;

and wherein the bleach composition is in the form of an aqueous solution.

Specific non-limiting examples include but are not limited to succinyl dichlorate and succinyl diperchlorate having the general formulas:

Succinyl dichlorate

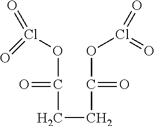

Succinyl diperchlorate

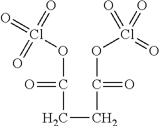

The preferred embodiment of the invention is an expedient method of preparing the bleach composition of the present invention comprising: contacting an acid anhydride with an aqueous solution comprising polyoxychlorine anions selected from at least one of chlorate anions having the general formula ClO₃⁻ and perchlorate anions having the general formula ClO₄; reacting the acid anhydride and polyoxychlorine anions until the acid anhydride is substantially depleted;

wherein the acid anhydride comprising two acyl groups bound at a common oxygen and wherein each of the acyl groups are bound to at least one of: an alkyl group having from 1 to 6 carbon atoms; an aryl group having 6 carbon atoms; the same carbon based backbone comprising 2 to 6 carbon atoms; and

wherein the bleach composition having a pH of less than or equal to 7.0.

The resulting organic acyl polyoxychlorine having the general formula:

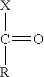

wherein (X) comprises a polyoxychlorine selected from at least one of a chlorate having the general formula ClO₃ and perchlorate having the general formula ClO₄;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and

wherein the bleach composition is in the form of an aqueous solution.

Specific non-limiting examples include but are not limited to succinyl chlorate and succinyl perchlorate having the general formulas: succinyl chlorate

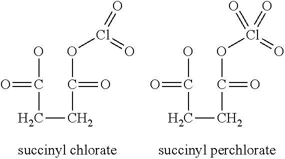

The expedient method produces aqueous bleach compositions and allows for ex-situ as well as in-situ generation of the said compositions, greatly increasing their utility. The expedient method of producing the bleach composition also eliminates the explosive hazards associated with producing and handling organic chlorate and organic perchlorates, and simplifies production by eliminating the need to separate the composition from the organic mother solvent.

The use of the said polyoxychlorine anions with acid anhydride results in bleach compositions with excellent stability until such time the solution contacts oxidizable organics exemplified by chromophores. The bleach compositions of the invention demonstrate excellent compatibility with many organic acids, acid anhydrides, and surfactants such a block copolymers exemplified by Pluronic 31R1, and Pluronic F 127. This greatly expands their use in formulations and applications where detergency, increased wetting, and dispersants are beneficial.

The bleach compositions of the invention can be produced by solid reactants, liquid reactants or a combination of solid and liquid reactants. The solid compositions may be in the form of a powder, granules and tablet.

As used herein, the term “aqueous solution” means the solution comprises water. The use of the term water however does not imply the water is necessarily pure or removed of mineral salts and gases common to most waters.

As used herein, “cyclic anhydride” describes compounds comprising two acyl groups bound to a common oxygen atom and having a carbon based backbone of 2 to 6 carbon atoms. Specific non-limiting examples of cyclic anhydrides include but are not be limited to succinic anhydride, methyl succinic anhydride, ethyl succinic anhydride, glutaric anhydride, adipic anhydride, maleic anhydride, pimelic anhydride, phthalic anhydride, suberic anhydride and the like. The carbon based backbone may include substituted branches as illustrated by methyl succinic anhydride and ethyl succinic anhydride. Backbone does not limit the carbon backbone structure to a simple chain of carbon atoms.

When a cyclic anhydride is reacted with a chlorate anion or perchlorate anion, one of the two acyl groups bound to the oxygen atom is cleaved from the oxygen, forming a reactive acyl group. The reactive acyl group is bound to a carbon based backbone comprising from 2 to 6 carbon atoms and terminating at a carboxyl functional group. The reactive acyl group reacts with the chlorate anion or perchlorate anion resulting in formation of the biocide composition comprising an acyl polyoxychlorine. A specific non-limiting example of an acyl polyoxychlorine resulting from a cyclic anhydride is succinyl chlorate having the general formula:

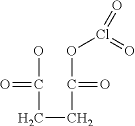

Wherein what was the reactive acyl group is shown bound by a chlorate having the general formula ClO₃, and a carbon based backbone comprising H₂C—CH₂ and terminating at a carboxyl functional group.

As used herein, “acid anhydride” describes compounds comprising two acyl groups bound at a common oxygen and wherein each of the acyl groups are bound to at least one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group. Specific non-limiting examples of acid anhydrides include but are not be limited to acetic anhydride, propanoic anhydride, ethanoic propanoic anhydride, butanoic anhydride, pentanoic anhydride, benzoic anhydride, succinic anhydride, maleic anhydride, phthalic anhydride, glutaric anhydride and the like.

When an acid anhydride is reacted with a chlorate anion or perchlorate anion, one of the two acyl groups bound to the oxygen atom is cleaved from the oxygen resulting in the formation of a reactive acyl group and releasing a carboxyl group. The reactive acyl group forms an acyl polyoxychlorine by reaction with either a chlorate or perchlorate anion.

An acid anhydride comprising two acyl groups bound to a common oxygen and wherein each acyl group is bound to its own 1 to 6 carbon based alkyl group results in the formation of an acyl polyoxychlorine bound to a 1 to 6 carbon based alkyl group, and a carboxylic acid comprising a carboxyl group bound to a 1 to 6 carbon based alkyl group. One non-limiting example comprises acetic anhydride reacting with an aqueous solution of chlorate anions to produce a solution comprising acetic acid and acetyl chlorate.

An acid anhydride comprising two acyl groups bound to a common oxygen and wherein each acyl group is bound to its own aryl group results in the formation of an acyl polyoxychlorine bound to a 6 carbon aryl group, and a carboxylic acid comprising a carboxyl group bound to a 6 carbon aryl group. One non-limiting example comprises benzoic anhydride reacting with an aqueous solution of chlorate anions to produce a solution comprising benzoic acid and benzoyl chlorate.

An acid anhydride comprising two acyl groups bound to a common oxygen atom and a carbon based backbone of 2 to 6 carbon atoms is defined as a “cyclic anhydride”, and results in the formation of an acyl polyoxychlorine bound to either a 2 to 6 carbon based alkyl group terminating at a carboxyl functional group, or a 2 carbon based alkene group terminating at a carboxyl functional group. One specific non-limiting example of an acid anhydride resulting in an acyl polyoxychlorine comprising a 2 to 6 carbon based alkyl group terminating at a carboxyl functional group is succinic anhydride. One non-limiting example of an acid anhydride resulting in an acyl polyoxychlorine comprising a 2 carbon based alkene group terminating at a carboxyl functional group is maleic anhydride.

An acid anhydride comprising two acyl groups bound to a common oxygen and common 6 carbon aryl group results in the formation of an acyl polyoxychlorine bound to a 6 carbon aryl group terminating at a carboxyl functional group. One specific non-limiting example is phthalic anhydride.

As used herein, “common carbon based backbone having from 2 to 6 carbon atoms” describes the basic carbon structure onto which both of the acyl groups and any substituted groups are bound. One specific non-limiting example is a starting acid chloride comprising methyl phthalyl dichloride reacted with chlorate anions to produce a methyl phthaloyl dichlorate. The common carbon based backbone comprises a 6 carbon phenyl group. The carbon atoms comprising the substituted methyl group and acyl groups are not included in the carbon atom count as it pertains to the “common carbon based backbone having from 2 to 6 carbon atoms”. Another non-limiting example is a cyclic anhydride represented by maleic anhydride wherein the common carbon based backbone comprises a 2 carbon alkene group onto which the two acyl groups are bound. Yet another example is a cyclic anhydride represented by succinic anhydride wherein the common carbon based backbone comprises a 2 carbon alkyl group onto which the two acyl groups are bound.

As used herein “polyoxychlorine anions” pertains to the production of the organic acyl polyoxychlorine. Polyoxychlorine anions comprise chlorate anions and/or perchlorate anions having the general formulas ClO₃⁻ and ClO₄ ⁻ respectively. The polyoxychlorine anions are selected from an alkali and alkali earth metal chlorate (ClO₃⁻) and alkali and alkali earth metal perchlorate (ClO₄⁻). Specific non-limiting examples include but are not be limited to: lithium chlorate, sodium chlorate, potassium chlorate, magnesium chlorate, calcium chlorate, lithium perchlorate, sodium perchlorate, potassium perchlorate, magnesium perchlorate, calcium perchlorate. Ammonium chlorate and ammonium perchlorate may also be suitable in some applications for the production of organic acyl polyoxychlorine.

As used herein, “polyoxychlorine” pertains to the general formula of the acyl polyoxychlorine and comprises at least one of chlorate having the general formula ClO₃ and perchlorate having the general formula ClO₄. The polyoxychlorine is bound to the acyl group of the organic acyl polyoxychlorine.

As used herein, “acid anhydride is substantially depleted” and “cyclic anhydride is substantially depleted” describes when the biocide composition or bleach composition has essentially been produced and is ready for use. The anhydrides have limited solubility and reaction with the polyoxychlorine anion results in the production of the acyl polyoxychlorine based biocide and bleach compositions. When the acid anhydride (or cyclic anhydride) is depleted, no additional biocide or bleach composition is produced. Therefore, substantially depleted shall mean when approximately 95% of the acid anhydride used to produce the biocide composition has been either reacted with the polyoxychlorine to produce the biocide composition or has hydrolyzed to its parent carboxylic acid. A specific non-limiting example is: combining succinic anhydride and sodium chlorate in an aqueous solution and allowing them to react to produce succinyl chlorate until at least 95 wt % of the succinic anhydride added to produce the biocide composition is either converted to succinyl chlorate or hydrolyzed to form succinic acid.

As used herein, “allkalinity doner” consumes hydrogen ions, thereby inducing an increase in the pH of the biocide solution and bleaching solution resulting from the compositions of the invention being contacted with water. Alkalinity donors are selected from alkali and alkali earth metals of bicarbonate, alkali and alkali earth metals of carbonate, alkali and alkali earth metals of phosphate, alkali and alkali earth metals of borate. Specific non-limiting examples include sodium bicarbonate, potassium bicarbonate, sodium carbonate, potassium carbonate, disodium phosphate, trisodium phosphate, sodium borate, sodium metasilicate, and the like.

As used herein, “reactive oxygen species” are any combination or variants of oxygen and oxygen radicals that are effective oxidizers. Specific non-limiting examples of reactive oxygen species include but are not limited to singlet oxygen, superoxide, and hydroxyl radicals.

As used herein “paper pulp” describes a slurry comprising at least: water; lignin; and cellulose. Paper pulp, the raw material in paper, is not naturally white; its light color or pure whiteness is the result of a multi-phased bleaching process. Bleaching removes or alters the color substances in the paper pulp by oxidizing the lignin based chromophores.

As used herein, “bleach composition” comprises at least one organic acyl polyoxychlorine and water. Bleach compositions of the invention are effective at oxidizing chromophores and oxidizable organics, thereby reducing or removing color and odor from laundry articles, paper pulp, and common hard-surface stains. Specific non-limiting examples of applications suitable for application of bleach compositions include: laundry, dishwashing, countertops, swimming pools, cooling towers, denture cleaning, carpet cleaning, paper pulp bleaching, decontamination of military equipment, and the like.

As used herein “proteinaceous” describes any of a group of complex organic macromolecules that contain carbon, hydrogen, oxygen, nitrogen, and usually sulfur and are composed of one or more chains of amino acids. Proteins are fundamental components of all living cells and include many substances, such as enzymes, hormones, and antibodies that are necessary for the proper functioning of an organism.

As used herein, “organic based contaminants” are carbon based compounds that can be at least partially oxidized by reactive oxygen species.

As used herein, “weight percent” and “wt %” unless otherwise stated is based on the total weight of the biocide solution.

As used herein, “effective amount of combustion suppressing boron donor” defines an effective amount of boron containing compound exemplified by borax and boric acid that can can reduce the combustion rate of the solid composition to a packing group having lower transportation and/or storage restrictions. Division 5.1 Oxidizer Testing in accordance with the Code of Federal Regulations, Title 49, and the United Nations Transportation of Dangerous Goods-Manual of Test and Criteria, Fourth revised edition (2003). Solid Division 5.1 materials are assigned packing groups using the following criteria [49 CFR .sctn.173.127(b)]: (i) Packing Group I is the sub-classification of any material which, in the 4:1 or 1:1 sample to cellulose ratio (by mass) tested exhibits a mean burning time less than the mean burning time of a 3:2 mixture, by mass, of potassium bromate and cellulose. (ii) Packing Group II is the sub-classification of any material which, in the 4:1 or 1:1 sample to cellulose ratio (by mass) tested exhibits a mean burning time less than the mean burning time of a 2:3 mixture, by mass, of potassium bromate and cellulose, and the criteria for Packing Group I are not met. (iii) Packing Group III is the sub-classification of any material which, in the 4:1 or 1:1 sample to cellulose ratio (by mass) tested exhibits a mean burning time less than the mean burning time of a 3:7 mixture, by mass, of potassium bromate and cellulose, and the criteria for Packing Groups I and II are not met.

As used herein, the term “tablet” refers to any geometric shape or size that comprises at least the ingredients of the compositions of the invention. The ingredients of the composition are agglomerated into a single mass to form a tablet. The tablet, upon contact with water produces a bleach solution.

As used herein, the term “recirculating systems” describes any open aqueous system that consist of a reservoir of water and a system of piping to transport the water, and wherein the water transported through the piping is eventually returned to the reservoir. Examples of recirculating systems include but are not limited to: cooling systems such as cooling towers and cooling ponds, swimming pools, fountains and feature pools.

As used herein, “hard surfaces” include: countertops; floors; walls; tables; cabinets; doors; doorknobs; food processing equipment, and the like.

Polyoxychlorine anion donors useful in the practice of the invention include alkali metal and alkali earth salts of chlorate, and perchlorate. Specific non-limiting examples include lithium chlorate, sodium chlorate, potassium chlorate, magnesium chlorate, calcium chlorate, lithium perchlorate, sodium perchlorate, potassium perchlorate, magnesium perchlorate, calcium perchlorate.

Alkalinity donors consume hydrogen ions, thereby inducing an increase in the pH of the aqueous bleach composition. Alkalinity donors maybe included during the generation of the bleach compositions or may be used to activate the acidified bleach compositions. Specific non-limiting examples include sodium bicarbonate, potassium bicarbonate, sodium carbonate, potassium carbonate, disodium phosphate, trisodium phosphate, sodium borate, sodium metasilicate and the like. An alkalinity donor may be provided by aqueous solutions being treated by the bleach composition.

Acid anhydrides suitable for use in this invention are those that react with the polyoxychlorine anion when the composition is contacted with water to produce at least one of a bleach solution. Specific non-limiting examples of acid anhydrides include but are not be limited to succinic anhydride, maleic anhydride, N-caprylic anhydride, acetic anhydride.

Aqueous bleach compositions should be produced while sustaining a pH of less than or equal to 7.0. If the bleach composition is not going to be used expeditiously, it is desirable to produce the bleach composition while sustaining the pH of less than 6.0. If the bleach composition is to be stored for More than a few days, it is desirable to produce the bleach composition while sustaining a pH of less than 5.0.

Sustaining a pH of less than 7.0 during the production of the acyl polyoxychlorine is desirable in order to obtain the higher yields of acyl polyoxychlorine. As is illustrated in the following results, elevated pH before or during the production of the acyl polyoxychlorine significantly diminishes the yield as illustrated by the low activity.

While the final pH was below 7.0, using sources of alkalinity such as sodium carbonate resulted in undesirable yields. This is believed to be due to the rapid dissolution of the alkalinity which elevates the pH of the aqueous solution. The solubility of the acid anhydride is limited, so it takes some time for the acid anhydride to dissolve, react with the polyoxychlorine anion and form acyl polyoxychlorine, and reduce the pH by formation of carboxylic acid. At a pH above 6.0, test results illustrate that the reactivity of the acyl polyoxychlorine is substantially increased. As the pH increases further, the bleach composition becomes increasingly unstable. This is evident by the continuous release of gas and the short period of time the bleach composition shows reactivity to oxidizable organics such as chromophores when the bleach composition approaches a pH of 7.0.

By sustaining a pH below or near about 7.0 during the generation of acyl polyoxychlorine, the formation of acyl polyoxychlorine takes place without significant decomposition so that the resulting biocide composition is substantially rich in acyl polyoxychlorine.

In the test, the stronger and highly soluble alkalinity sources exemplified by sodium carbonate elevated the pH quickly, and it is believed much of the succinyl chlorate produced quickly decomposed before the pH was reduced sufficiently to stabilize the remaining succinyl chlorate.

In order to produce a “use as is” bleach composition, it is desirable to include a pH buffer such as sodium bicarbonate, disodium phosphate and the like to ensure that as the organic acyl polyoxychlorine is generated, the pH does not rise much above approximately 7.0 in order to reduce the level of decomposition of the organic acyl polyoxychlorine. However it is desirable to produce a bleach solution having a pH above 5.0 in so that it is ready to use as is, with need for additional pH adjustment to activate the bleach solution.

To produce a bleach composition suitable for storage or for use in applications where the aqueous solution treated with the bleach composition is greater than about 5.0, it is desirable to allow the aqueous solution to remain below 5.0 to further increase the stability of the acyl polyoxychlorine as it is produced, thereby increasing the resulting yield of the bleach composition.

Bleach compositions comprising succinyl chlorate and succinyl perchlorate were produced and tested for storage stability over a period of 15 days. The pH of the stock bleach compositions were measured and recorded. Whey protein was used to determine the relative reactivity of the bleach compositions. Before performing the whey protein test, sodium bicarbonate was added to a 10 ml sample of the bleach composition to increase the pH and activity of the acyl polyoxychlorine. The 10 ml sample was swirled to remove excess carbon dioxide gas. Then a small scoop of whey protein was added, the sample swirled, and the observed reactivity was recorded.

pH Effect on the Storage Stability of Aqueous Solutions
Comprising Succinyl Chlorate and Succinyl Perchlorate

| | | | | | Whey |
|---|---|---|---|---|---|
| | | | | | Protein |
| | | | | | Test |
| | | | | Biocide | Storage |
| Sample ID | | | | Com- | (days) |
| 100 ml | Sodium | Magnesium | Succinic | position | 8 days/ |
| water | Chlorate | Perchlorate | Anhydride | pH | 15 days |
| 1 gm SA/ | 1.0 gm | n/a | 1.0 gm | 3.60 | vigorous/ |
| 1 gm ClO₃ | | | | | vigorous |
| 1 gm SA/ | n/a | 1.0 gm | 1.0 gm | 3.42 | vigorous/ |
| 1 gm ClO₄ | | | | | vigorous |

The stability test clearly illustrated that storing the bleach compositions is acid pH of less than 4.0 stabilized the bleach solution until such time as the pH was increased and the bleach composition was contacted by an oxidizable organic.

pH Effect on production of succinyl chlorate
using strong alkali Na₂CO₃

| | Succinic | | | |
|---|---|---|---|---|
| | Anhydride | | | |
| | w/Pluronic | | | |
| Sodium | 31R1 | Sodium | Sequence of | Whey |
| Chlorate | 10:1 wt ratio | Carbonate | Addition | Protein Test |
| 1.0 gm | 1.0 gm | 1.0 gm | Na₂CO₃ added | pH 6.32 |
| | | | first pH ~10.2 | extremely weak |
| | | | | poor activity |
| 1.0 gm | 1.0 gm | 1.0 gm | Added | pH 6.32 |
| | | | together | Better but weak |
| | | | | slow RxN |
| | | | | w/whey |

In this test, sodium carbonate was used during the production of succinyl chlorate. The sodium carbonate was added at two different times to see the effect on production of the succinyl chlorate. The sample pretreated with sodium carbonate showed extremely weak reactivity with the whey protein even though the final pH of the bleach composition was less than 7.0. The addition of the sodium carbonate together with the succinic anhydride and sodium chlorate showed better results. However, the bleach composition was comparatively weak when compared to bleach solutions produced using either sodium bicarbonate as a buffer or no buffer addition at all. Regardless, the bleach composition was produced, but other more favorable methods are demonstrated and disclosed.

pH effect on generation of succinyl chlorate and activity

| | Succinic | | | |
|---|---|---|---|---|
| | Anhydride | | | Whey |
| Sodium | w/Pluronic | Sodium | Sequence of | Protein |
| Chlorate | 31R1 | Bisulfate | Addition | Test |
| 1.0 gm | 1.0 gm | 1.2 gm | NaHSO₄ added | pH 2.70 |
| | | | first | No observable |
| | | | pH ~2.80 | Reaction |
| | | | 2.0 gm NaHCO₃ | pH 6.54 |
| | | | | vigorous w/foam |

In this example, the pH was brought to the other extreme by addition of sodium bisulfate to first suppress the pH. The succinic anhydride and sodium chlorate where then added and allowed to react to produce the succinyl chlorate. The resulting bleach composition was test for activity by addition of whey protein to a 10 ml sample. The test showed no observable reaction between whey protein and succinyl chlorate at a pH of 2.70. However, when sodium bicarbonate was added to elevate the pH above 5.0, the bleach composition reacted vigorously with the whey protein, generating large amounts of gas, resulting in formation of foam.

The molar ratio of polyoxychlorine anions comprising at least one of chlorate having the general formula ClO₃⁻ and perchlorate having the general formula ClO₄⁻ and acid anhydride ranges from 10:1 to 1:10 respectively, more preferably 5:1 to 1:5, and most preferably 2:1 to 1:2.

Acid anhydrides have limited solubility in the aqueous solutions comprising polyoxychlorine anions. In order to achieve desirable levels of conversion of the acid anhydride to the acyl polyoxychlorine, the acid anhydride and polyoxychlorine should be in intimate contact before the acid anhydride hydrolyzes to form its parent carboxylic acid. Powder or liquid compositions should be dispersed in the aqueous solution comprising the polyoxychlorine anions. Solid compositions in the form of granules of tablets by their very nature place the reactants comprising polyoxychlorine anions and acid anhydride in intimate contact.

Liquid or powered acid anhydrides should be mixed in the aqueous solution of effectively dispersed to form a suspension. This ensures intimate contact between the acid anhydride is intimately contacted with the peroxychlorine anions as the reactive acyl group is formed, thereby increasing the conversion of the acid anhydride to the desirable acyl polyoxychlorine instead of the undesirable hydrolysis of the reactive acyl group to a carboxylic acid.

Solid compositions of this invention may be in the form of powders, granules, and tablets. Solid composition may be packaged as a single composition, or as separate ingredients to be later mixed then added to water or individually added to water.

Solid compositions in the form of granules and powders maybe dissolved in water then fed thru a chemical pump. Liquid biocide compositions can be made in advance and packaged into a drum. A chemical pump or educator system can be used to deliver the biocide composition.

Solid compositions may be packaged in single use packages. Examples include a single pouch in which a mixed solid composition is stored or a multi-compartment pouch or package. The single use package is opened and the contents are added to water and mixed to form the bleach composition. The bleach composition is then applied to hard surface such as counter tops, doorknobs, cabinets, and the like for the purpose of disinfection.

Solid and compositions can also be packaged as bleaches for laundry or formulated with dry or non-aqueous laundry detergents. Liquid biocide composition and bleach composition can be packaged and used as a non-chlorine bleach to laundry washing machines and for soaking prior to washing.

Surfactants can be incorporated into the composition or the bleach solution to reduce the surface tension, improve wetting, improve detergency, and provide foaming capability. Specific non-limiting examples include block copolymer surfactants sold under the trade name Pluronic® manufactured by BASF. Surfactants can also be useful for pretreating solid acid anhydrides to improve their dispersion in the aqueous solution to prevent coalescing or the anhydride and separation by settling or floatation. Specific non-limiting examples include Pluronic® 31R1, Pluronic® 103P, Lutrol® 68 Microprill and the like.

Anti-caking agents can improve flowability and reduce clumping of dry compositions and ingredient. I can be advantageous to apply an anti-caking agent exemplified by magnesium carbonate light, untreated fumed silica and treated fumed silica. Fumed silica is sold under the trade name CAB-O-SIL® and is manufactured by Cabot Corporation. Anti-caking agents can also reduce the hygroscopic nature of the polyoxychlorine anion donors as well as the entire solid composition.

Dispersants such as tripolyphosphate can be useful in dispersing soils in sterilant and other applications in which the biocide solution must penetrate deposits to effectively inactivate microorganisms.

### Testing the Bleach Composition

### Dispersing the Acid Anhydride

Acid anhydrides generally have slight to limited solubility in water. They slowly hydrolyze to their parent acid. When succinic anhydride is added in a granular/flake form to water that has been treated with sodium chlorate, the tendency is to either coalesce and sink to the bottom, or entrap gas and float. Since the chlorate anions must collide with the acid anhydride to convert the succinic anhydride to the desired succinyl chlorate, large clumps of succinic anhydride reduce the efficiency of conversion and subsequent yield of the succinyl chlorate. One way to improve the dispersion of a solid form of acid anhydride is to reduce the particle size of the acid anhydride and combine the acid anhydride with a surfactant.

A mixture was made by combining 5 grams of succinic anhydride was combined with 0.5 ml of Pluronic® 31R1 which is a block copolymer of polyethylene oxide and polypropylene oxide. The two were mixed, then 9.5 grams of sodium bicarbonate where added and mixed. The ingredients where added to a coffee grinder and ground to form a fine fluffy powder that was easily removed from the grinder.

100 ml of cold water (8° C.) was added to a flask and 1.5 grams of the mixture was combined with 0.50 grams of sodium chlorate then added to the flask. The solution was manually mixed for approximately 30 seconds and allowed to rest undisturbed. The solution was hazy and no settling of particulate was observed. After approximately 15 minutes the solution was clear, the pH was 6.28. The resulting solution comprises a bleach composition of succinyl chlorate.

To a 10 ml sample of the bleach composition a ceramic cylinder prepared using the protocol from AOAC 966.04 was added. The reaction upon addition of the cylinder was spontaneous. Vigorous gas evolution occurred and after 35 seconds the reaction appeared to be completed.

The test illustrated that combining solid acid anhydride with surfactant exemplified by Pluronic 31R1 and reducing the particle size resulted in a readily dispersible composition that did not require continuous mixing. This would be advantageous for producing powerful bleach compositions from solid reagents.

In this example, 20 grams of succinic anhydride was combined with 1.0 grams Pluronic F127 and ground in a coffee grinder to form a mixture. 1.0 gram of the mixture was combined with 1.0 grams sodium chlorate and 1.0 gram sodium bicarbonate and added to 100 ml of water and mixed. The solution was clear in approximately 3 minutes, the pH was 6.05.

2.5 ml of bleach solution was combined with 7.5 ml of water and swirled. A scoop of whey protein was added and swirled. The sample demonstrated excellent decomposition of the whey protein.

These tests illustrate that combining a surfactant exemplified by the block copolymers sold under the trade name Pluronic® to the ground solid acid anhydride significantly improves the dispersion of the acid anhydride and results in effective conversion of the acid anhydride to the desired acyl polyoxychlorine resulting the formation of the bleach composition. The formation of the bleach composition using this technique can be achieved with very limited mechanical mixing.

### Solid Organic Acyl Polyoxychlorine

To 100 ml of tap water, 5 grams of magnesium perchlorate was added and mixed, followed by addition of 5 grams of succinic anhydride. The aqueous solution was vigorously mixed until no succinic anhydride was observable in the solution. Approximately 25 ml of solution was stored in a flask and allowed to dry by slowly evaporating the water. The bottom of the flask had a film of crystals having an appearance similar to snowflakes. 25 ml of cold tap water was added and swirled to dissolve the crystals. A 10 ml vial was filled and a small amount of sodium bicarbonate was added and swirled to elevate the pH to over 5.0. Whey protein was added and the vial was swirled. The whey protein rapidly decomposed forming a cloud of gas and formation of foam on the top of the vial.

This test showed that an acidic aqueous solution of succinyl perchlorate is sufficiently stable to form a solid succinyl perchlorate. The solid succinyl perchlorate could be reconstituted to form an aqueous solution while retaining its reactivity toward whey protein.

Organic perchlorates have been known to be explosive in both liquid and solid forms. It may be advantageous to include an additive in aqueous solutions sold in the commercial and retail markets that induces decompositions when the organic acyl polyoxychlorine is concentrated, thereby preventing formation of solid crystals.

### Bleaching Stains

Two sets of cotton swatches were prepared by soaking two swathes in Tart Cherry Juice and two swatches in Coffee. The cotton swatches where laid out to dry. 800 ml of water was added to a 1000 ml beaker, a magnetic stirring rod was added and the beaker was placed on top of a magnetic stirrer. 75 grams of magnesium perchlorate was added with the stirrer sustaining a vortex approximately ⅔ the distance from the top of the solution to the stirring rod. 75 grams of succinic anhydride was slowly added and allowed to mix until no observable succinic anhydride remained. 75 grams of sodium bicarbonate was slowly added allowing sufficient time for release of carbon dioxide without vigorous gas release and the associated localized increases in pH that can accelerate decomposition of the succinyl perchlorate. The resulting bleach solution was diluted with additional water to obtain 1000 ml of bleach solution.

To a 500 ml beaker, 165 ml of water as measured in a graduated cylinder and added to the beaker. 335 ml of bleach solution was added to obtain 500 ml of diluted bleach solution. This dilution process was repeated with another 500 ml beaker so that two beakers of 500 ml of diluted bleach solution were available.

One of the Tart Cherry Juice stained swatches and one of the coffee stained swatches was added to each of the diluted bleach solutions. The swatches were periodically moved with a Teflon spoon liberating large volumes of gas. After 5 minutes, the swatches where removed from the diluted bleach solutions and added to a washing machine along with a towel to enhanced their movement in the machine. A small amount of surfactant Triton DF-12 from Dow Chemical was added to the machines dispenser. The cycle was set for 55 minutes using hot water wash. After washing the contents were removed from the machine, placed into the drier and dried on high temperature until dried.

The swatches were placed next to the swatches that had not been bleached, as well as a sample of cotton swatch not stained. The bleached samples had been restored to the whiteness of the original cotton swatches. No remaining stain was observed on either the tart cherry juice stained or the coffee stained swatches.

### Laundry Bleaching

To 200 ml of water, 10 grams of magnesium perchlorate was added and mixed until dissolved. 10 grams of maleic anhydride was added and mixed until the suspension was completely dissolved. Two white towels stained with dried coffee were added to a front loaded washing machine. The bleach solution was added to the bleach dispenser and Triton DF-12 surfactant was added to the detergent dispenser. The machine was set to wash whites and started. After 55 minutes the towels were removed and dried. The towels were cleaned of the coffee stains. There was no distinguishable difference between the portions of the towels stained with coffee and those that were not.

What is claimed is:

1. A bleach composition in the form of an aqueous solution comprising:
at least one organic acyl polyoxychlorine having the general formula 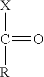
wherein (X) comprises a,polyoxychlorine selected from at least one of a chlorate having the general formula ClO₃ and perchlorate having the general formula ClO₄;
wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water.

2. The bleach composition according to claim 1, wherein the organic acyl polyoxychlorine comprises at least one of succinyl chlorate and succinyl perchlorate having the general formulas:

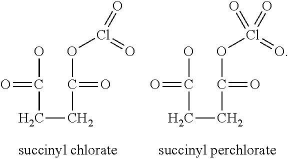

3. The bleach composition according to claim 1, wherein the organic acyl polyoxychlorine comprises at least one of glutaryl chlorate and glutaryl perchlorate having the general formulas:

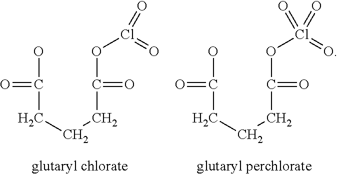

4. The bleach composition according to claim 1, wherein the organic acyl polyoxychlorine comprises at least one of adipoyl chlorate and adipoyl perchlorate having the general formulas:

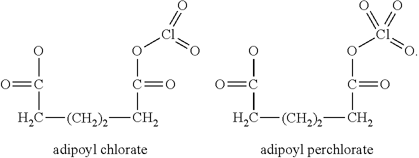

5. The bleach composition according to claim 1, wherein the organic acyl polyoxychlorine comprises at least one of acetyl chlorate and acetyl perchlorate having the general formulas:

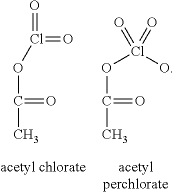

6. The bleach composition according to claim 1, wherein the organic acyl polyoxychlorine comprises at least one of maleyl chlorate and maleyl perchlorate having the general formulas:

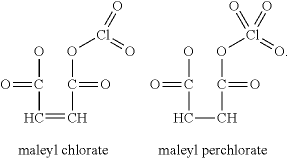

7. A method of making a bleach composition comprising at least one organic acyl polyoxychlorine having the general formula 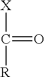
wherein (X) comprises a polyoxychlorine selected from at least one of a chlorate having the general formula ClO₃ and perchlorate having the general formula ClO₄;
wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water, the method comprising:
contacting an acid anhydride comprising two acyl groups bound at a common oxygen and wherein each of the acyl groups are bound to one of: an alkyl group having from 1 to 6 carbon atoms; an aryl group having 6 carbon atoms; a common carbon based backbone comprising 2 to 6 carbon atoms, with an aqueous solution comprising polyoxychlorine anions selected from at least one of chlorate anions having the general formula ClO₃⁻ and perchlorate anions having the general formula ClO₄⁻; and
reacting the acid anhydride and polyoxychlorine anions until the acid anhydride is substantially depleted to form the bleach composition having a pH of less than or equal to 7.0.

8. The method according to claim 7, wherein the pH is less than 6.0.

9. The method according to claim 7, wherein the pH is less than 5.0.

10. A method of making a bleach composition comprising at least one organic acyl polyoxychlorine having the general formula 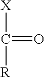
wherein (X) comprises a polyoxychlorine selected from at least one of a chlorate having the general formula ClO₃ and perchlorate having the general formula ClO₄;
wherein (R) comprising one of: 2 to 6 carbon based alkyl group terminating at a carboxyl functional group; 2 carbon based alkene group terminating at a carboxyl functional group; and water, the method comprising:
contacting a cyclic anhydride comprising two acyl groups bound to a common oxygen atom and having a common carbon based backbone having from 2 to 6 carbon atoms with an aqueous solution comprising polyoxychlorine anions selected from at least one of a chlorate anions having the general formula ClO₃⁻ and a perchlorate anions having the general formula ClO₄⁻; and
reacting the cyclic anhydride and polyoxychlorine anions until the cyclic anhydride is substantially depleted to form the bleach composition having a pH of less than or equal to 7.0.

11. The method according to claim 10, wherein the pH is less than 6.0.

12. The method according to claim 10, wherein the pH is less than 5.0.

13. A bleach composition in the form of an aqueous solution comprising succinyl chlorate having the general formula 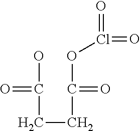
and water.

14. A method of making a bleach composition in the form of an aqueous solution comprising succinyl chlorate having the general formula 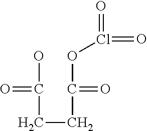
and water, the method comprising:
contacting succinic anhydride with an aqueous solution comprising chlorate anions having the general formula ClO₃⁻; and
reacting the succinic anhydride and chlorate anions until the succinic anhydride is substantially depleted to form the bleach composition having a pH of less than or equal to 7.0.

15. The method according to claim 14, wherein the pH is less than 6.0.

16. The method according to claim 14, wherein the pH is less than 5.0.

17. A bleach composition in the form of an aqueous solution comprising succinyl perchlorate having the general formula 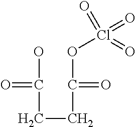
and water.

18. A method of making a bleach composition in the form of an aqueous solution comprising succinyl perchlorate having the general formula 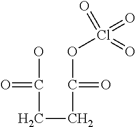
and water, the method comprising:
contacting succinic anhydride with an aqueous solution comprising perchlorate anions having the general formula ClO₄⁻; and
reacting the succinic anhydride and perchlorate anions until the succinic anhydride is substantially depleted to form the bleach composition having a pH of less than or equal to 7.0.

19. The method according to claim 18, wherein the pH is less than 6.0.

20. The method according to claim 18, wherein the pH is less than 5.0.

21. A bleach composition in the form of an aqueous solution comprising:
an organic diacyl dipolyoxychlorine having the general formula 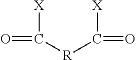
wherein (R) comprises a common carbon based backbone having from 2 to 6 carbon atoms;
wherein (X) comprises a polyoxychlorine selected from at least one of a chlorate having the general formula ClO₃ and perchlorate having the general formula ClO₄, and water.

22. The bleach composition according to claim 21, wherein the organic diacyl dipolyoxychlorine comprises succinyl dichlorate having the general formula:

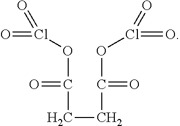

23. The bleach composition according to claim 22, wherein the organic diacyl dipolyoxychlorine comprises succinyl diperchlorate having the general formula:

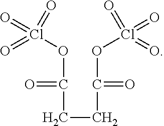

24. A method of making a bleach composition in the form of an aqueous solution comprising an organic diacyl dipolyoxychlorine having the general formula 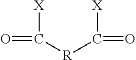
wherein (R) comprises a common carbon based backbone having from 2 to 6 carbon atoms,
wherein (X) comprises a polyoxychlorine selected from at least one of a chlorate having the general formula ClO₃ and perchlorate having the general formula ClO₄, and water, the method comprising:
contacting a diacyl dichloride group having a common carbon based backbone of 2 to 6 carbon atoms with a solution comprising an organic solvent and polyoxychlorine anions selected from at least one of a chlorate anions having the general formula ClO₃⁻ and a perchlorate anions having the general formula ClO₄⁻;
reacting the diacyl dichloride and polyoxychlorine anions to produce a solution substantially rich in organic diacyl dipolyoxychlorine; and
separating the organic diacyl dipolyoxychlorine with water to produce the aqueous bleach composition having a pH of less than 5.0.

25. A method of bleaching chromophores comprising: contacting chromophores with an aqueous bleach composition comprising organic acyl polyoxychlorine having the general formula: 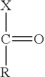
wherein (X) comprises a polyoxychlorine selected from at least one of a chlorate having the general formula ClO₃ and perchlorate having the general formula ClO₄; wherein (R) comprising at least one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group;
wherein the aqueous bleach composition has a pH of greater than 4.5.

26. A method according to claim 25, further comprising forming the aqueous bleach by contacting an acid anhydride comprising two acyl groups bound at a common oxygen and wherein each of the acyl groups are bound to one of: an alkyl group having from 1 to 6 carbon atoms; an aryl group having 6 carbon atoms; a common carbon based backbone comprising 2 to 6 carbon atoms, with an aqueous solution comprising polyoxychlorine anions selected from at least one of chlorate anions having the general formula ClO₃⁻; perchlorate anions having the general formula ClO₄⁻; and reacting the acid anhydride and polyoxychlorine anions until the acid anhyride is substantially depleted to form the aqueous bleach.

27. A method of bleaching chromophores comprising: contacting chromophores with an aqueous bleach composition comprising organic diacyl dipolyoxychlorine having the general formula: 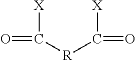
wherein (X) comprises a polyoxychlorine selected from at least one of a chlorate having the general formula ClO₃ and perchlorate having the general formula ClO₄; wherein (R) comprising a common carbon based backbone having from 2 to 6 carbon atoms;
wherein the aqueous bleach composition has a pH of greater than 4.5.

28. A bleach composition for bleaching chromophores of paper pulp in the form of an aqueous solution comprising acetyl chlorate having the general formula 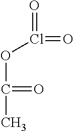
and water.

29. A bleach composition for bleaching chromophores of paper pulp in the form of an aqueous solution comprising acetyl perchlorate having the general formula 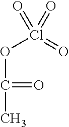
and water.

30. A method of bleaching chromophores of paper pulp comprising contacting paper pulp with an aqueous bleach composition comprising at least one of an acetyl chlorate and acetyl perchlorate having the general formulas 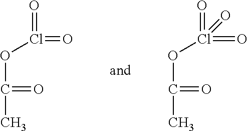
respectively, and
wherein the aqueous bleach composition has a pH of greater than 4.5.
